(19) United States
(12) Patent Application Publication
(10) Pub. No.: US 2023/0003468 A1
(43) Pub. Date: Jan. 5, 2023

(54) HEAT TRANSFER UNIT

(71) Applicant: Mahle International GmbH, Stuttgart (DE)

(72) Inventors: Pierre-Yves Guiton, Aichwald (DE); Yasin Kilinc, Mattighofen (AT); Frank Stange, Stuttgart (DE)

(21) Appl. No.: 17/855,770

(22) Filed: Jun. 30, 2022

(30) Foreign Application Priority Data
Jul. 1, 2021 (DE) 10 2021 206 945.2

(51) Int. Cl. F28F 19/06; F28F 21/08; F28D 9/00; B23K 1/00; B23K 35/22

(52) U.S. Cl. CPC F28F 19/06; F28F 21/084; F28D 9/005; F28D 9/0093; B23K 1/0012; B23K 35/226; F28D 2021/0089

(57) ABSTRACT

A heat transfer unit for a motor vehicle may include a metallic heat transfer block and a base plate. The heat transfer block may include channels that are configured to be flowed through. The base plate may include an outer region and a material bonding region. The base plate may be exposed towards the outside and may be materially bonded to the heat transfer block in the material bonding region. The base plate may be formed out of an aluminium, an aluminium alloy, or a wrought aluminium alloy. The outer region of the base plate may comprise a protective coating produced by anodising at least in regions, and the material bonding region of the base plate may not have a protective coating produced by anodising.

### CROSS-REFERENCE TO RELATED APPLICATION

This application claims priority to German Patent Application No. DE102021206945.2, filed on Jul. 1, 2021, the contents of which is hereby incorporated by reference in its entirety.

### TECHNICAL FIELD

The invention relates to a heat transfer unit for a motor vehicle. The invention also relates to a method for producing the heat transfer unit.

### BACKGROUND

Generically, a heat transfer unit comprises a metallic multi-part heat transfer block with channels that can be flowed through and a base plate. The base plate is connected to the heat transfer block on one side and is exposed to the outside in regions. In order to protect the heat transfer unit from corrosion, the heat transfer unit can be covered with a protective coating.

From DE 10 2011 086 414 A1 an anodic protective coating and from US 2019 024 990 A1 a method for producing a protective coating from alpha-Al2O3 are known.

Disadvantageously, producing the heat transfer unit with a protective coating is highly complex. When the heat transfer unit is completely coated with the protective coating, special equipment is necessary. For new designs of the heat transfer unit, new equipment or an adaptation of the existing equipment is always necessary. When only the individual parts of the heat transfer unit are coated with the protective coating, the corrosion can develop at connecting points of the individual parts.

The object of the invention therefore is to state an improved or at least alternative embodiment for a heat transfer unit of the generic type, with which the described disadvantages are overcome.

### SUMMARY

A heat transfer unit is provided for a motor vehicle. The heat transfer unit comprises a metallic heat transfer block with channels that can be flowed through and a base plate having an outer region and a material bonding region. The base plate is exposed with the outer region to the outside and materially bonded to the heat transfer block in the material bonding region. According to the invention, the base plate is formed from aluminium or from an aluminium alloy or from a wrought aluminium alloy. The outer region of the base plate comprises a protective coating produced by anodising at least in regions and the material bonding region of the base plate does not have a protective coating produced by anodising.

Anodising is a known electrochemical method and can take place in a manner known to the person skilled in the art. Accordingly, the base plate can be arranged in an electrolyte solution and a direct current be conducted through the base plate. In the process, the base plate can be employed as anode. By way of the direct current, hydrogen can be collected on the cathode and oxygen can be collected on the anode. By way of this, a protective coating of aluminium oxide can build up on the base plate. The base plate can be punched out of a base plate material or out of an aluminium sheet coil before or after the anodising. It is to be understood that as soon as the base plate is punched out of the base plate material or out of the aluminium sheet coil following the anodising, the base plate material or the aluminium sheet coil is anodised.

The protective coating on the base plate produced by the anodising consists of aluminium oxide and can protect the base plate from corrosion even in an aggressive environment. The protective coating covers the outer region of the base plate that is exposed to the outside at least in regions and protects the base plate. By contrast, no protective coating is present in the material bonding region of the base plate. Because of this, the material bonding of the base plate to the heat transfer block is not prevented by the protective coating of aluminium oxide. Practically, the heat transfer block is formed out of a metal which can be materially bonded to the base plate. Because of this, the base plate can be materially bonded or joined to the heat transfer block in a simplified manner. Advantageously, further seals and coverings for protecting the connecting points between the base plate and the heat transfer block in the heat transfer unit are no longer required. Because of this, the lifespan of the heat transfer unit can be increased and producing the heat transfer unit can be significantly simplified.

During the material bonding or joining, the base plate and the heat transfer block are permanently and not detachably connected to one another. In connection with the present invention, the term “not detachably” means that the connection between the base plate and the heat transfer block can only be separated by destroying the base plate and/or the heat transfer block. The base plate and the heat transfer block can be directly connected to one another or a shapeless substance—for example adhesive—can be additionally used. The material bonding or joining includes for example welding, soldering and adhesive bonding.

The outer region can be contiguous or not contiguous. A contiguous outer region is surrounded by the material bonding region on all sides. A non-contiguous outer region includes multiple regions which are separated from one another by the material bonding region. The material bonding region can be contiguous or non-contiguous. A contiguous material bonding region is surrounded by the outer region on all sides. A non-contiguous material bonding region includes multiple regions which are separated from one another by the outer region. The outer region and the material bonding region jointly represent the outer surface of the base plate completely. With respect to the base plate, the outer region of the base plate is exposed to the outside and can be arranged within the heat transfer unit.

Advantageously it can be provided that the heat transfer unit is a heat exchanger and the heat transfer block comprises the first channels for a first fluid and the second channels for a second fluid. The first channels and the second channels are heat-transferringly connected to one another for the heat exchange between the fluids in the heat transfer block. Advantageously, the heat exchanger can be a stacked plate oil-water cooler and the first channels of the heat transfer block be designed for water and the second channels of the heat transfer block for oil. However, further embodiments of the heat exchanger are advantageously also conceivable.

Advantageously it can be provided that the heat transfer unit is a cooling plate and the channels of the heat transfer block are designed for cooling water.

Advantageously it can be provided that the protective coating has a thickness between 10 μm and 20 μm, preferentially 15 μm. Advantageously it can be provided that the base plate has a thickness between 3 mm and 4 mm. Advantageously it can be provided that the base plate is formed out of two sub-base plates that are identical in shape and size and materially bonded to one another. The two sub-plates can be soldered to one another.

The invention also relates to a method for producing the heat transfer unit for a motor vehicle described above. In the method, the following steps are carried out in the following sequence: producing the protective coating on the base plate by anodising, simultaneously keeping the material bonding region of the base plate free of the protective coating to be produced or subsequently exposing the material bonding region of the base plate or subsequently exposing the material bonding region of the base plate by striping the produced protective coating; and materially bonding the base plate to the heat transfer block in the material bonding region that has been kept free or exposed by stripping. Here, the base plate can be punched out of a base plate material or out of an aluminium sheet coil before or after the anodising.

Anodising is a known electrochemical method and can take place in a manner known to the person skilled in the art. Accordingly, the base plate can be arranged in an electrolyte solution and a direct current be conducted through the base plate. The base plate can be employed as anode. By way of the direct current, hydrogen can be accumulated on the cathode and oxygen on the anode. Because of this, a protective coating of aluminium oxide can build up on the base plate. It is to be understood that as soon as the base plate is punched out of the base plate material or out of the aluminium sheet coil after the anodising, the base plate material or the aluminium sheet coil is anodised.

In the method, the protective coating produced by the anodising is produced in the outer region of the base plate at least in regions and the material bonding region does not have any protective coating. Because of this, the base plate or the base plate material, in the method, can be materially bonded to the heat transfer block in a simple manner. The heat transfer block is practically formed out of a metal which can be materially bonded to the base plate. Through the material bonding of the base plate and of the heat transfer block, further seals and coverings for protecting the connecting points between the base plate and the heat transfer block are no longer required. Because of this, the lifespan of the heat transfer unit can be increased and the production of the heat transfer unit can be significantly simplified.

Advantageously it can be provided that prior to producing the protective coating the material bonding region is covered with a protective film for keeping it clear of the protective coating. Following the producing of the protective coating and before the material bonding, the protective film is peeled off.

Advantageously it can be provided that when producing the protective coating the protective coating is also produced in the material bonding region. Following the producing of the protective coating and before the material bonding, the protective coating is now chemically stripped in the material bonding region. In addition it can be provided that during the chemical stripping of the protective coating in the material bonding region, the outer region is covered with a protective film. Following the covering of the outer region, the protective coating is chemically stripped in the material bonding region preferentially by pickling. Alternatively, the protective coating can be mechanically stripped in the material bonding region.

Advantageously it can be provided that during the material bonding the base plate and the heat transfer block are soldered to one another or soldered to one another under vacuum or under a controlled atmosphere, preferentially without flux, soldered to one another or connected to one another in a roll-bonding process.

### BRIEF DESCRIPTION OF THE DRAWINGS

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

It shows, in each case schematically:

FIG. 1 an exploded view of a heat transfer unit according to the invention;

FIGS. 2 and 3 schematic views of a method according to the invention carried out differently.

### DETAILED DESCRIPTION

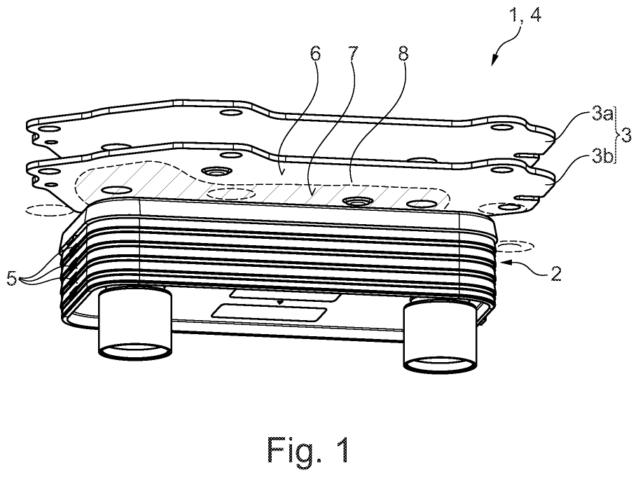

FIG. 1 shows an exploded view of a heat transfer unit 1 for a motor vehicle according to the invention. The heat transfer unit 1 comprises a metallic heat transfer block 2 and a base plate 3.

In this exemplary embodiment, the heat transfer unit 1 is a heat exchanger 4 and the heat transfer block 2 is formed out of multiple stacked plates 5. Between the stacked plates 5, the first channels for a first fluid and the second channels for a second fluid are formed, so that the two fluids in the heat transfer block 2 can exchange heat with one another through the stacked plates 5. The heat exchanger 4 can be for example an oil-water cooler, wherein the first channels of the heat transfer block 2 are designed for water and the second channels of the heat transfer block 2 for oil.

The base plate 3 in this exemplary embodiment is formed out of two sub-base plates 3a and 3b that are identical in shape and size, which are materially bonded, preferentially soldered to one another. The base plate 3 consists of aluminium or of an aluminium alloy or of a wrought aluminium alloy and has a thickness between 3 mm and 4 mm. The base plate 3 comprises an outer region 6 and a material bonding region 7, which together completely cover or represent an outer surface of the base plate 3. In the heat transfer unit 1, the base plate 3 is exposed with the outer region 6 to the outside. In the material bonding region 7, the base plate 3 is materially bonded to the heat transfer block 2.

The outer region 6 of the base plate 3 comprises a protective coating 8 of aluminium oxide produced by anodising. The material bonding region 7 by contrast does not comprise a protective coating 8 of aluminium oxide produced by anodising, so that the base plate can be more easily connected to the heat transfer block 2 in a materially bonded manner. Here, the heat exchanger block 2 is formed out of a metal which allows being materially bonded to the base plate 3.

In the following, a method 9 for producing the heat transfer unit 1 according to the invention is explained in more detail.

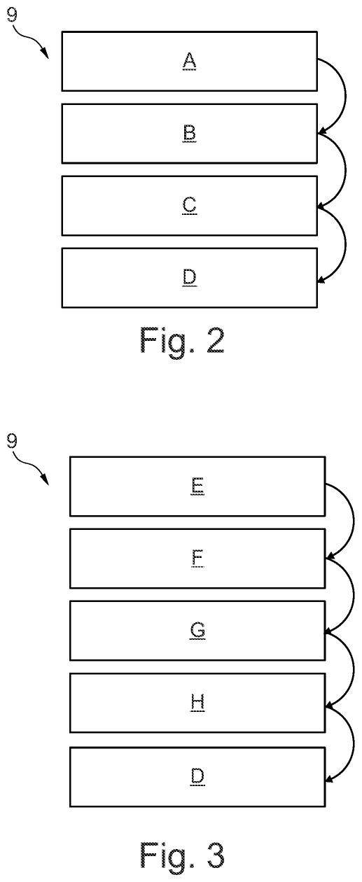

FIG. 2 shows a schematic view of the method 9 according to the invention in a possible embodiment. Here, the material bonding region 7 of the base plate 3 is covered with a protective film in step A and defined by the same. In a subsequent step B, the protective coating 8 is produced on the base plate 3 by anodising in a manner known to the person skilled in the art. Since the material bonding region 7 is covered with the protective film, the protective coating 8 is exclusively produced in the outer region 6 outside the material bonding region 7. Following the step B, the protective film, in a step C, is peeled off and the material bonding region 7 thereby exposed. In a step D, the base plate 3 is now materially bonded to the heat transfer block 2 in the material bonding region 7. Advantageously, the base plate 3 and the heat transfer block 2 can be soldered to one another or soldered to one another under vacuum or soldered to one another under a controlled atmosphere, preferentially without flux or connected to one another in a roll-bonding process. This alternative is characterised by particularly few method steps.

FIG. 3 shows a schematic view of the method 9 according to the invention in a possible further embodiment. Here, the protective coating 8, in the step E, is produced on the entire base plate 3—that is in the outer region 6 and in the material bonding region 7—by anodising in a manner known to the person skilled in the art. After this, the outer region 6, in a step F, is covered with a protective film and thereby the material bonding region 7 defined. In a subsequent step G, the protective coating 8 is now chemically stripped in the material bonding region 7, preferentially by pickling. After this, the protective film, in a step H, is removed from the outer region 6. Following this, the base plate 3, in the step D explained above, is materially bonded to the heat transfer block 2 in the material bonding region 7.

1. A heat transfer unit for a motor vehicle, comprising:
a metallic heat transfer block including channels that are configured to be flowed through; and
a base plate including an outer region and a material bonding region, the base plate is exposed towards the outside and materially bonded to the heat transfer block in the material bonding region;
wherein the base plate is formed out of an aluminium, an aluminium alloy, or a wrought aluminium alloy; and
wherein the outer region of the base plate comprises a protective coating produced by anodising at least in regions, and the material bonding region of the base plate does not have a protective coating produced by anodising.

2. The heat transfer unit according to claim 1, wherein the heat transfer unit is a heat exchanger and the heat transfer block comprises first channels for a first fluid and second channels for a second fluid; and
the first channels and the second channels are heat-transferringly connected to one another in the heat transfer block for the heat exchange between the fluids.

3. The heat transfer unit according to claim 2, wherein the heat exchanger is a stacked plate oil-water cooler and the first channels of the heat transfer block are configured for water and the second channels of the heat transfer block are configured for oil.

4. The heat transfer unit according to claim 1, wherein the heat transfer unit is a cooling plate and the channels of the heat transfer block are configured for cooling water.

5. The heat transfer unit according to claim 1, wherein:
the protective coating has a thickness between approximately 10 μm and approximately 20 μm; and/or
the base plate has a thickness between approximately 3 mm and approximately 4 mm; and/or
the base plate is formed out of two sub-base plates, the sub-base plates are identical in shape and size and materially bonded to one another.

6. A method for producing the heat transfer unit of claim 1, the method comprising:
producing the protective coating on the base plate by anodising;
simultaneously keeping the material bonding region of the base plate free of the protective coating to be produced or subsequently exposing the material bonding region by stripping the produced protective coating from the material bonding region of the base plate; and
materially bonding the base plate to the heat transfer block in the material bonding region which has been kept free or has been exposed by stripping.

7. The method according to claim 6, wherein prior to producing the protective coating, the material bonding region is covered with a protective film for keeping it free of the protective coatings; and
after the producing of the protective coating and prior to the material bonding the protective film is peeled off.

8. The method according to claim 7, wherein during the producing of the protective coating, the protective coating is also produced in the material bonding region; and
after the protective coating has been produced and prior to the material bonding, the protective coating is mechanically or chemically stripped in the material bonding region.

9. The method according to claim 8, wherein during the chemical stripping of the protective coating in the material bonding region, the outer region is covered with a protective film; and
following the covering of the outer region, the protective coating is chemically stripped in the material bonding region.

10. The method according to claim 6, wherein during the material bonding, the base plate and the heat transfer block are soldered to one another, or connected to one another in a roll-bonding process.

11. The heat transfer unit according to claim 1, wherein the protective coating has a thickness of approximately 15 μm.

12. The method according to claim 6, wherein during the material bonding, the base plate and the heat transfer block are soldered to one another under vacuum.

13. The method according to claim 6, wherein during the material bonding, the base plate and the heat transfer block are soldered to one another under a controlled atmosphere.

14. The method according to claim 6, wherein during the material bonding, the base plate and the heat transfer block are soldered to one another without flux.

15. The method according to claim 8, wherein during the chemical stripping of the protective coating in the material bonding region, the outer region is covered with a protective film; and
following the covering of the outer region, the protective coating is chemically stripped in the material bonding region via pickling.

16. A heat transfer unit for a motor vehicle, comprising:
a heat transfer block including first channels configured for a first fluid and second channels configured for a second fluid, wherein the first and second channels are thermally connected; and
a base plate including an outer region and a material bonding region;
wherein the base plate is materially bonded to the heat transfer block in the material bonding region, and the outer region is at least partially covered by a protective coating.

17. The heat transfer unit according to claim 16, wherein the heat transfer unit includes a heat exchanger; and
the heat exchanger includes a stacked plate oil-water cooler.

18. The heat transfer unit according to claim 16, wherein the first fluid includes water, and the second fluid includes oil.

19. The heat transfer unit according to claim 16, wherein the heat transfer unit includes a cooling plate and the first and second channels are configured for cooling water.

20. The heat transfer unit according to claim 15, wherein:
the base plate includes a first plate and a second plate;
the first and second plates includes similar configurations; and
the first plate is connected to the second plate.
